(19) United States
(12) Patent Application Publication
(10) Pub. No.: US 2016/0232545 A1
(43) Pub. Date: Aug. 11, 2016

(54) SYSTEM AND METHOD FOR DETECTING CHANGES OF EMPLOYMENT

(71) Applicant: MASTERCARD INTERNATIONAL INCORPORATED, Purchase, NY (US)

(72) Inventors: Randall K. Shuken, Westport, CT (US); DEBASHIS GHOSH, Charlotte, NC (US)

(73) Assignee: MASTERCARD INTERNATIONAL INCORPORATED, Purchase, NY (US)

(21) Appl. No.: 14/618,585

(22) Filed: Feb. 10, 2015

(51) Int. Cl. G06Q 30/02; G06Q 20/20

(52) U.S. Cl. CPC G06Q 30/0205; G06Q 30/0204; G06Q 20/202; G06Q 30/0255

(57) ABSTRACT

Systems and methods of generating a marketing target list based on information in a collection of payment card transaction data. An iterative querying process is configured to identify payment card holders who have recently experienced a job change by recognizing certain patterns in payment card transaction data that are correlated with changes of employment. Various patterns may be identified the payment card transaction data as job change indicators to facilitate the compilation of a timely and reliable list of payment card holders who are very likely to have experienced a recent change of employment.

### FIELD OF TECHNOLOGY

The present disclosure relates to financial data processing and more particularly to identifying a set of marketing targets based on payment card transaction data.

### BACKGROUND

Numerous consumer profiling techniques and population modeling techniques are commonly used by marketers to identify potential customers. The success rate of a marketing campaign is often greatly increased by directing offers and/or advertisements to carefully selected groups of potential customers that are identified using consumer profiling and modeling techniques. For example, marketers can offer better deals to a small appropriately targeted set of consumers than to the general public, because there is a better chance of the targeted offer being converted into a sale.

Event based marketing and consumer profiling techniques involve identifying potential consumers around the time that they experience certain life changing events such as marriages, home purchases, birth of children, change of jobs and retirement. It is well known that these consumers are far more likely to change their consuming habits around the time of such life changing events and may then be far more likely to respond favorably to certain marketing efforts. For example, newly married couples are far more likely than other consumers to consider opening new bank accounts or purchasing certain insurance products. Similarly, new home owners are far more likely than other consumers to purchase appliances and furniture, for example.

Shortly after consumers make their initial purchases or form new post-event spending habits in response to a life changing event, they again become much less likely to respond to additional marketing efforts related to those purchases and habits. Thus, it is extremely important for marketers to identify these target consumers quickly around the time of their respective life changing events.

Lists of consumers who have recently experienced life changing events, and/or consumers who are expected to soon experience such life changing events are commonly generated by various information providers for sale to advertisers and marketing agencies. These lists have traditionally been generated by searching public real estate records for real estate transactions, searching U.S. Mail databases for address change information, and by accessing proprietary databases by information providers such as Acxiom Corporation of Little Rock, Ark., for example. However, there is typically a delay of about six months between the life changing event of a consumer and the availability of such information from these traditional data sources.

The delayed availability of information indicating a changing event significantly reduces the value of the information. Lists that are compiled based on such stale information are likely to include a large number of consumers who are no longer good marketing targets.

### SUMMARY

An aspect of the present disclosure includes a method of generating a marketing target list by receiving a collection of payment account transaction data from a payment account network, and executing a number of query iterations on the collection of payment account transaction data. After a first iteration identifies in which a first query is executed on the received collection of payment transaction data, each subsequent iteration includes executing a different query on only payment transaction data of the set of payment accounts identified in the previous iteration. Each different query identifies a next more refined set of payment accounts that each include a next different job change indicator. A list is then generated including the payment account holders of the payment accounts identified in a last one of the iterations.

Another aspect of the present disclosure includes a system for generating a marketing target list. The system includes one or more processing centers, a data warehouse coupled to the processing centers, and a number of point of sale terminals coupled to the processing centers. The point of sale terminals configured for communicating the transaction data from corresponding points of sale to the processing centers, and the data warehouse stores a collection of payment account transaction data. According to aspects of the present disclosure, the processing centers are configured for receiving the collection of payment account transaction data from the data warehouse executing a plurality of query iterations on the collection transaction data. After a first iteration in which a first query is executed on the received collection of payment transaction data, each subsequent iteration includes executing a different query on only payment transaction data of the set of payment accounts identified in the previous iteration, each different query identifying a next more refined set of payment accounts that each include a next different job change indicator. The processing centers then generate a list including the payment account holders of the payment accounts identified in a last one of the iterations.

Additional features and advantages of the present disclosure are described below. It should be appreciated by those skilled in the art that this disclosure may be readily utilized as a basis for modifying or designing other structures, systems and processes for carrying out the same purposes of the present disclosure. It should also be realized by those skilled in the art that such equivalent implementations do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The particular features and advantages of the present disclosure will be apparent from the detailed description set forth below in conjunction with the drawings in which like reference characters identify corresponding aspects throughout.

FIG. 1 is a conceptual block diagram illustrating a general example of a payment device transaction system according to aspects of the present disclosure.

FIG. 2 is a process flow diagram illustrating a method for generating list of recent job changers based on transaction data according to aspects of the present disclosure.

### DETAILED DESCRIPTION

The detailed description set forth herein makes reference to the accompanying drawings, which show various aspects of the present disclosure by way of illustration. While these various aspects are described in sufficient detail to enable those skilled in the art to practice the disclosure, it should be understood that other embodiments and implementations may be realized and that logical and mechanical changes may be made without departing from the scope of the disclosure. Thus, the detailed description herein is presented for purposes of illustration only and not of limitation. For example, the steps recited in any of the method or process descriptions may be executed in any order and are not limited to the order presented. Moreover, references to a singular embodiments may include plural embodiments, and references to more than one component may include a singular embodiment, for example.

When a person experiences certain life events, such as a change in employment, their interest in certain products or services often changes, as well. An important goal of marketers is to detect a consumer's changing purchasing interests and to design more effective marketing campaigns which target these individuals before they have changed their consumer profile and settled into new purchasing habits. Previously known techniques for identifying consumers around the time of certain life changing events have been hindered by delayed availability of information used to detect the life changing events. Thus, event based marketing campaigns are often implemented too late to effectively influence a large portion of the targeted audience.

Changes in employment are an increasingly common life changing event that can strongly affect a consumer's purchasing profile and spending patterns. In the recent past, it was common for individuals to remain employed by a single employer for decades, so opportunities for marketers to target job changers were few and far between. More recently, it has become common for individuals to change jobs much more frequently, e.g., every two or three years. Thus, the opportunities for marketers to target recent job changers are becoming more frequent.

Job change events are particularly interesting to marketers because consumers who are changing jobs may suddenly become interested in many different types of purchases and services than usual. For example, if a financial advisor in a bank is informed that a potential customer has changed jobs, the financial advisor will have a rare opportunity to convince the potential customer to move their retirement accounts or other investment portfolios from their former employer, to one of the bank's accounts.

According to aspects of the present disclosure, life changing events such as changes in employment can be reliably detected much more quickly than by implementing previously known event based marketing techniques.

A method of identifying payment card holders who have recently experienced a job change according to an aspect of the present disclosure is implemented by recognizing certain patterns in payment card transaction data that are correlated with changes of employment. This improves the field of event based marketing by allowing marketers to identify a much larger audience of potential targets before they have already settled into new post-event spending habits.

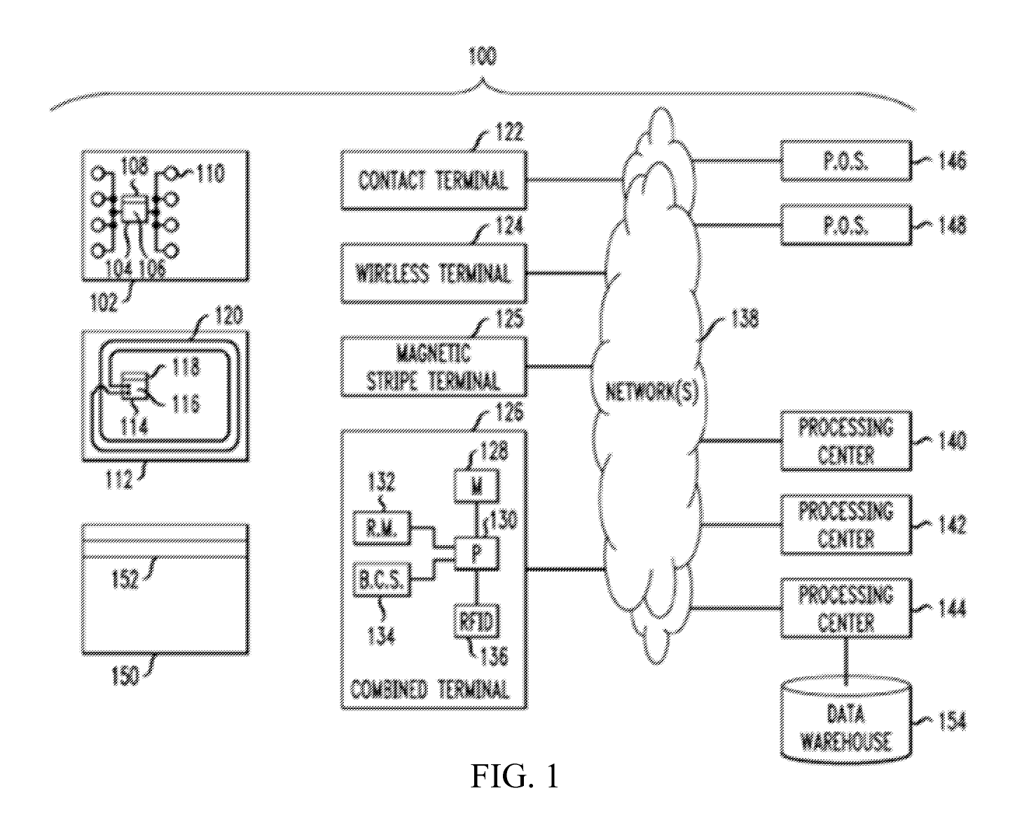

FIG. 1 depicts a system 100 including various possible components according to aspects of the present disclosure. It should be noted that for completeness and generality, presentation of certain physical cards such as known credit or debit cards to certain terminals will be described. However, aspects of the present disclosure involve credit accounts and transaction data that is not dependent on a physical card or terminal, for example. In FIG. 1, the system 100 includes a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed for communicating transaction data according to aspects of the present disclosure. Other types of devices used in lieu of or in addition to “smart” or “chip” cards 102, 112 could include a conventional card 150 having a magnetic stripe 152, an appropriately configured cellular telephone handset, and the like. Indeed, techniques can be adapted to a variety of different types of cards, terminals, and other devices, configured, for example, according to a payment system standard (and/or specification).

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store protected transaction card data such as, e.g., a user's primary account number (“PAN”) and/or personal identification number (“PIN”). The memory portions or units 108, 118 can store the operating system of the cards 102, 112. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

As noted, cards 102, 112 are examples of a variety of payment devices that can be employed. The primary function of the payment devices may not be payment, for example, they may be cellular phone handsets. Such devices could include cards having a conventional form factor, smaller or larger cards, cards of different shape, key fobs, personal digital assistants (PDAs) or tablets, appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to implement appropriate functionality. The applications can be, for example, application identifiers (AIDs) linked to software code in the form of firmware plus data in a card memory such as an electrically erasable programmable read-only memory (EEPROM). Again, note that “smart” or “chip” cards are not necessarily required and a conventional magnetic stripe card can be employed; furthermore, as noted above, one or more embodiments are of interest wherever credit is extended in a credit account, including accounts having no physical card.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (for example, a virtual private network, such as the BANKNET® virtual private network (VPN) of MasterCard International Incorporated of Purchase, N.Y., USA). More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 140, 142, 144 can include, for example, a host computer of an issuer of a payment device (or processing functionality of other entities discussed in other figures herein). Issuers can include issuers for cardless credit card accounts as well.

Many different retail or other establishments, as well as other entities, generally represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to implement appropriate functionality. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone or tablet.

Again, conventional magnetic stripe cards 150 can be used instead of or together with “smart” or “chip” cards, and again, cards and other payment devices are described for completeness, as one or more embodiments are of particular interest in the context of card-not-present Internet transactions.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification, from a UPC code or RFID tag on a product to be purchased.

The above-described devices 102, 112 can be ISO 7816-compliant contact cards or devices or NFC (Near Field Communications) or ISO 14443-compliant proximity cards or devices, for example. In operation, card 112 can be touched or tapped on the terminal 124 or 128, which then transmits the electronic data to the proximity IC chip in the card 112 or other wireless device. Magnetic stripe cards can be swiped in a well-known manner. In some instances, the card number is simply provided via web site, in a card-not present transaction or the like.

One or more of the processing centers 140, 142, 144 can include a database such as a data warehouse 154; for example, to hold transaction data as described below. It should be understood by persons skilled in the relevant arts that a database or data warehouse 154 may be directly linked to the one or more processing centers 140, 142, 144 or may be linked to the processing centers via the network(s) 138, for example.

In the context of card-not-present Internet transactions, the card or other device is not presented to terminal 122, 124, 125, or 126. Rather, appropriate account information (e.g., primary account number (PAN), cardholder name, cardholder address, expiration date, and/or security code, and so on) is provided to a merchant by a consumer using a web site or the like. The merchant then uses this information to initiate the authorization process.

According to aspects of the present disclosure, dynamic spend ranges are generated based on the transaction data. The transaction data in the data warehouse 154 may include different categories, such as consumer credit card transaction data, consumer debit card transaction data and commercial credit card transaction data, for example. The transaction data may include data descriptive of transactions in various different countries and/or regions, for example. The transaction data may indicate transaction amounts, location, product or service types, a transaction product segment or categories, and numerous other transaction classifications, for example.

According to an aspect of the present disclosure, payment card transaction data is retrieved from a data warehouse in a payment card network and analyzed to detect changes in patterns of transactions by the payment cardholder that can be correlated to a likelihood that the payment card holder has recently experienced of a job change event having recently occurred. The database of payment card transaction data is searched for certain attributes such as spending pattern changes that may be correlated to a life change event such as a job change. Computer code may be executed to process a file of transaction data on a server or query a database of transaction data in the data warehouse, for example, to flags the cardholder accounts that include those attributes.

For example, a first query may be run across transaction data of all payment card accounts in a payment card database to search for a substantial change in the pattern of the respective account holders' gas station use, which may indicate a job change. Accounts that included such pattern changes are identified and additional queries are implemented to search for other significant changes in payment account holder purchasing patterns. Ultimately a very large group of account holders is substantially narrowed into a sub group of the account holders that are very likely to have recently changed jobs.

Although aspects of the present disclosure are described in terms of payment card transaction data, such as credit card transaction data and debit card transaction data, it should be understood that these aspects may also include transaction data that is not associated with a physical card. Because electronic payment devices such as smart phones, tablets, and numerous wireless electronic devices are increasingly being used for conducting transactions in place of traditional payment cards, persons having ordinary skill in the art should appreciate the term payment card as used herein includes any of these types of alternative payment devices. The term payment account is used herein to represent payment card accounts or accounts associated with any of the alternative payment devices.

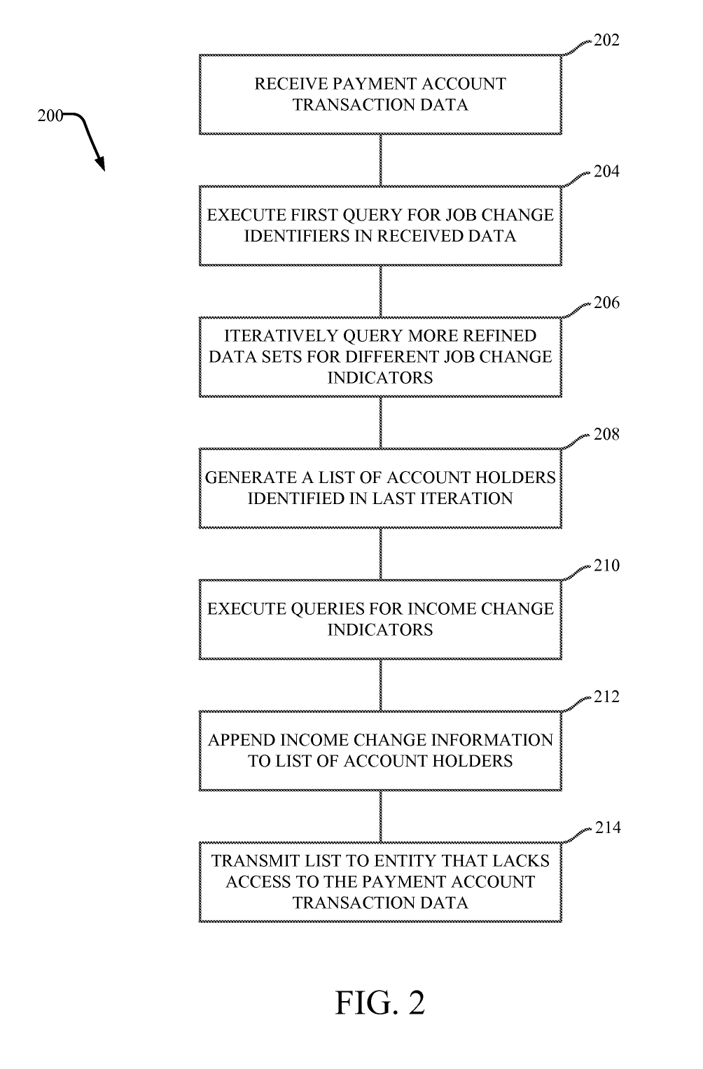

A method of generating a marketing target list according to an aspect of the present disclosure is described with reference to FIG. 2. The method 200 includes receiving a collection of payment account transaction data from a payment account network at block 202. The payment card network may include one or more processing centers, a data warehouse coupled to the processing centers, and a plurality of point of sale terminals coupled to the processing centers, for example. The point of sale terminals are configured for communicating the transaction data from corresponding points of sale to the processing centers. Some or all of the transaction data may be stored in the data warehouse.

The payment card transaction data may include a plurality of account holder names, account holder addresses, account holder telephone numbers, transaction purchase amounts, transaction dates, transaction locations, and/or transaction types associated with corresponding account holder purchase transactions, for example. The method 200 also includes executing a first query on a first collection of the payment account transaction data at block 204. According to aspects of the present disclosure, the first query identifies a first set of payment accounts that each include a first job change indicator.

To more reliably identify account holders who are likely to have experienced a recent job change, the method may include executing a plurality of iterations at block 206 in which each iteration including executing a different query on only payment transaction data of the set of payment accounts identified in the previous iteration. According to aspects of the present disclosure, each different query identifies a next more refined set of payment accounts that each include a next different job change indicator. At block 208, the method includes generating a list of the payment account holders of the payment accounts identified in a last one of the iterations. The list of payment account holders may include contact information of the payment account holders, for example.

According to aspects of the present disclosure, the job change indicators may include: recent change in gas station transaction locations; recent change in amount of gas purchased; recent change in lunchtime food purchase locations; recent change in haircut provider locations; recent change in haircut purchase amounts; recent change in morning coffee shop location; recent change in amount of purchases at clothing retail locations; recent change in retail clothing transaction location, recent change in grocery store location; and recent change in amount of purchases at a grocery store, for example.

At block 210, the method includes executing one or more additional queries on the payment accounts identified in the last one of the iterations. The additional queries are configured to identify whether the listed payment account holders are associated with an increased income indicator, a decreased income indicator or an unchanged income indicator. At block 212, the method optionally includes appending information to the list indicating whether the listed payment account holders are associated with one or more of the increased income indicator, the decreased income indicator or an unchanged income indicator based on a result of the additional queries.

At block 214, the method includes transmitting the list to an entity that does not have access to the payment account transaction data. According to aspects of the present disclosure, the entity may include marketers or advertisers who may be interested in marketing to a refined target audience of likely recent job changers, for example.

Although the term ‘query’ is used herein to describe various steps for identifying subsets of data in a collection of data, it should be understood that this term is not limited to an particular type of query command, statement or process or any particular programming language, algorithm or technique for identifying data in a database, for example.

According to aspects of the present disclosure, one type of indicator of a job change is based on the geography of particular spending transactions such as the location of a gas station, location of grocery store, location of hair salon. such as changes in patterns of purchases at certain gas stations. We will use the gas stations and the path in the pattern. Because they usually have a very specific path on their way to and from work.

The geographic indicators in purchase transaction data provides cues with respect to whether a payment account holder had changed certain habits, based on the locations of items that they habitually purchase such as gasoline, coffee and lunch, for example. The location or regular gas station transactions is an indicator of a card holder's route to work. So, a sudden change in the location of regular gasoline purchases may indicate an account holder's recent job change. Similarly, the location of regular morning transactions at coffee shop and the location of regular lunchtime transactions at a restaurant are good indicators of a cardholders place of employment. So, sudden changes in location of morning transactions in a coffee shop and changes in location of lunchtime restaurant transactions may also indicate an account holder's recent job change.

In addition to geographic indicators, the amounts of certain transactions, such as amount of gasoline purchased may indicate that a consumer has changed their commuting distance, possibly because of a job change.

According to another aspect of the present disclosure, once a likely job change has been detected in the transaction data, additional queries can be used to determine whether or not the recent job change provided increased or decreased income to the account holder. For example, sudden changes in certain transaction amounts may also provide insight into whether a job change resulted in the account holder having increased income, decreased income or no change in income.

The transaction data may also be queried based on type of purchases to identify certain discretionary purchases that can be indicative of income level. This may indicate whether the new job resulted in increased income, decreased income or no change in income. For example, transactions above a predetermined threshold amount at a clothing retailer may indicate that a job change providing increased income. The threshold may be based on a ratio of the account holder's short term clothing store spend amounts to their typical annual clothing store spend amount, for example. Other large discretionary spending by a person who has changed jobs may indicate that they received a signing bonus, for example. Conversely, certain patterns in the transaction data such as sudden reductions in overall spending, or discretionary spending may indicate that an account holder has settled into the new job with an equal or lesser salary than their previous job.

The transaction data generally does not include information to identify particular product purchases. However, according to aspects of the present certain assumptions can be made based on the purchase location. For example, it can be inferred that certain patterns of purchasing at a gas station are gasoline purchases and that transactions at a clothing retailer are most likely for clothing purchases. Other job change indicators may be based on the price level or affordability of a retail transaction location. A change in spending from a less expensive grocery chain to a more expensive grocery chain may be in indicator of increased income based on a job change for example.

Some changes in spending patterns are stronger indicators of a potential job change than others. For example, changes in regular at gasoline station transaction locations and changes in lunchtime food purchase locations are stronger indicators of a likely job change than changing clothing location purchases. According to aspects of the present disclosure, the reliability of a determination that a job change has occurred may be increased by comparing various combinations of the identified job change indicators to check for contradictions or to reinforce the determination, for example. Probability based mathematical techniques such as logistic regression may be used to evaluate a determination that a job change has occurred and mitigate the effects of contradictory indicators by assigning appropriate weights to various job change indicators according to their predictive strength, for example.

According to aspects of the present disclosure, one of the indicators of a job change may be a change in the residential zip code of an account holder. However, inferences from residential zip code changes alone do not reliably indicate a job change because account holders may change addresses without changing jobs. Also, because fewer employers are paying for employees to relocate, employee are more frequently working from home. In such cases a job change may not be accompanied by change of the account holder's address in a U.S. Mail database or an Acxiom database, for example.

According to aspects of the present disclosure, a list of account holders, and/or account holder households is generated in which each listed account holder and/or person in their household is very likely to have recently changed jobs. This defines an audience of likely recent job changers that can be used to substantially improve the effective of event based marketing efforts. The list may include each account holder name along with contact information to facilitate targeted marketing to the listed account holders. According to another aspect of the present disclosure, the list may include information indicating whether a respective card holder has likely experienced an increase in income, a decrease in income, or no change in income as a result of their recent job change.

According to another aspect of the present disclosure, the list may be segmented based on income brackets that are associated with certain types of payment accounts. For example, certain gold card accounts may indicate that corresponding cardholders are probably in an annual income bracket of between $50,000 and $100,000 while certain platinum card accounts may indicate that corresponding cardholders are probably in an annual income bracket of greater than $100,000. The list of potential job changers generated according to aspects of the present disclosure may be supplemented with information indicating likely income brackets for the each of the listed card holder accounts. This may increase the value of the list by allowing marketers to target more appropriate goods and services to the recent job changers. The list of potential job changers generated according to aspects of the present disclosure may be used independently by marketers or may be integrated with other third party data sources to improve their reliability and utility, for example.

The processing of payment card transaction data received from a payment card network to identify a life change event, such as a recent job change, according to aspects of the present disclosure provides substantial improvement to the field of event based marketing by greatly reducing the latency of time sensitive marketing information.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although aspects of the present disclosure are described in terms of various types of payment cards and payment card accounts, it should be understood that the disclosure is not limited to physical cards or accounts associated with physical cards. For example, various payment devices, such as smart phones, tablet computers, and other wireless devices may be used in place of a payment cards within the scope of the present disclosure. It should be understood that any such payment device can be used in the same way as a payment card according to aspects of the present disclosure.

Although the present disclosure has been described in connection with the embodiments of the present disclosure illustrated in the accompanying drawings, it is not limited thereto. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although specific components have been set forth, it will be appreciated by those skilled in the art that not all of the disclosed components are required to practice the disclosed configurations. Moreover, certain well known components have not be described, to maintain focus on the disclosure.

For firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disc storage, magnetic disk storage or other magnetic storage devices, or other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative or instructions and data. The instructions and data are configured to cause one or more processors to implement the functions outlined in the claims.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps presently existing or later to be developed that perform substantially the same functions or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method of generating a marketing target list, comprising:
receiving a collection of payment account transaction data from a payment account network;
executing a first query on the collection of payment account transaction data, the first query identifying a first set of payment accounts that each include a first job change indicator.

2. The method of claim 1, further comprising:
generating a list of payment account holders identified in the first set of payment accounts.

3. The method of claim 1, comprising:
executing a plurality of iterations, each iteration including executing a different query on only payment transaction data of the set of payment accounts identified in the previous iteration, each different query identifying a next more refined set of payment accounts that each include a next different job change indicator; and
generating a list of the payment account holders of the payment accounts identified in a last one of the iterations.

4. The method of claim 3, in which one or more of the job change indicators are in the group consisting of:
recent change in gas station transaction locations;
recent change in amount of gas purchased;
recent change in lunchtime food purchase locations;
recent change in haircut provider locations;
recent change in haircut purchase amounts;
recent change in morning coffee shop location;
recent change in amount of purchases at clothing retail locations;
recent change in retail clothing transaction location;
recent change in grocery store location; and
recent change in amount of purchases at a grocery store.

5. The method of claim 3, further comprising:
transmitting the list to an entity that does not have access to the payment account transaction data.

6. The method of claim 5, wherein the entity is a marketing agency.

7. The method of claim 3, further comprising:
executing one or more additional queries on the payment accounts identified in the last one of the iterations, the additional queries configured to identify whether the listed payment account holders are associated with an increased income indicator, a decreased income indicator or an unchanged income indicator.

8. The method of claim 7, further comprising:
appending information to the list indicating whether the listed payment account holders are associated with one or more of the increased income indicator, the decreased income indicator or an unchanged income indicator based on a result of the additional queries.

9. The method of claim 3, wherein the list of payment account holders includes contact information of the payment account holders.

10. The method of claim 1, wherein the payment account network comprises:
one or more processing centers;
a data warehouse coupled to the processing centers, the data warehouse storing the transaction data;
a plurality of point of sale terminals coupled to the processing centers, the point of sale terminals configured for communicating the transaction data from corresponding points of sale to the processing centers.

11. The method of claim 1, wherein the payment account transaction data includes a plurality of account holder names, account holder addresses, account holder telephone numbers, transaction purchase amounts, transaction dates, transaction locations, and/or transaction types associated with corresponding account holder purchase transactions.

12. A system for generating a marketing target list, comprising:
one or more processing centers;
a data warehouse coupled to the processing centers, the data warehouse storing a collection of payment account transaction data; and
a plurality of point of sale terminals coupled to the processing centers, the point of sale terminals configured for communicating the transaction data from corresponding points of sale to the processing centers,
wherein the one or more processing centers are configured for:
receiving the collection of payment account transaction data from the data warehouse; and
executing a first query on the collection of payment account transaction data, the first query identifying a first set of payment accounts that each include a first job change indicator.

13. The system of claim 13, wherein the one or more processing centers are configured for generating a list of payment account holders identified in the first set of payment accounts.

14. The system of claim 13, wherein the one or more processing centers are configured for:
executing a plurality of iterations, each iteration including executing a different query on only payment transaction data of the set of payment accounts identified in the previous iteration, each different query identifying a next more refined set of payment accounts that each include a next different job change indicator; and
generating a list of the payment account holders of the payment accounts identified in a last one of the iterations.

15. The system of claim 14, in which one or more of the job change indicators are in the group consisting of:
recent change in gas station transaction locations;
recent change in amount of gas purchased;
recent change in lunchtime food purchase locations;
recent change in haircut provider locations;
recent change in haircut purchase amounts;
recent change in morning coffee shop location;
recent change in amount of purchases at clothing retail locations;
recent change in retail clothing transaction location;
recent change in grocery store location; and
recent change in amount of purchases at a grocery store.

16. The system of claim 14, wherein the one or more processing centers are configured for:
transmitting the list to an entity that does not have access to the payment account transaction data.

17. The system of claim 14, wherein the one or more processing centers are configured for:
executing one or more additional queries on the payment accounts identified in the last one of the iterations, the additional queries configured to identify whether the listed payment account holders are associated with an increased income indicator, a decreased income indicator or an unchanged income indicator.

18. The system of claim 17, wherein the one or more processing centers are configured for:
appending information to the list indicating whether the listed payment account holders are associated with one or more of the increased income indicator, the decreased income indicator or an unchanged income indicator based on a result of the additional queries.
